(19) United States
(12) Patent Application Publication
(10) Pub. No.: US 2025/0103907 A1
(43) Pub. Date: Mar. 27, 2025

(54) METHOD AND SYSTEM TO OPTIMIZE THE HYPER-PARAMETERS OF DISCRETE DIGITAL SIGNAL RECOVERY FOR DATA PROCESSING SYSTEMS

(71) Applicant: Continental Automotive Technologies GmbH, Hannover (DE)

(72) Inventors: David Gonzalez Gonzalez, Egelsbach (DE); Osvaldo Gonsa, Frankfurt (DE); Hiroki Iimori, Yokahama (JP); Giuseppe Thadeu Freitas de Abreu, Bremen (DE); Andreas Andrae, Frankfurt am Main (DE)

(73) Assignee: Continental Automotive Technologies GmbH, Hannover (DE)

(21) Appl. No.: 18/723,686

(22) PCT Filed: Dec. 14, 2022
(86) PCT No.: PCT/EP2022/085958

§ 371 Date: Jun. 24, 2024

(30) Foreign Application Priority Data
Dec. 23, 2021 (DE) 10 2021 214 984.7

(51) Int. Cl. G06N 3/0985

(52) U.S. Cl. CPC G06N 3/0985

(57) ABSTRACT

A computer-implemented method to optimize hyper-parameters of discrete digital signal recovery for data processing system that is characterized by a measurement matrix (A), the method comprising, a processing unit (PU) receiving a noisy observation vector (y) of scalar measurements (N) from an unknown signal vector (x) linearly transformed by the measurement matrix (A), where the unknown signal vector (x) is composed of quantities randomly sampled from a finite discrete alphabet set ( [symbol] ), recovering the unknown signal vector (x) from the noisy observation vector (y) by optimizing a first hyper-parameter (λ) and a second hyper parameter (α) by performing a standard supervised mini-batch training, whereby a training data set ( [symbol] ) is split (L) into mini-batches ( [symbol] ) and every mini-batch ( [symbol] ) is composed of many pairs of signal vectors (x) and noisy observation vectors (y), initializing a first function (\hat{X}^{IDLS-Net}) computing a second function (β_{i,j}(t)) computing a third function (b(t)), fourth function (B(t)) for every layer (t), calculating the first function (\hat{X}^{IDLS-Net}) based on the result of the second function (β_{i,j}(t)), third function (b(t)), fourth function (B(t)), whereby a loss function (Loss (t)) is determined at the end of every layer (t′) and the max operation is taken over the mini-batch ( [symbol] ), updating the first hyper-parameter (λ) and the second hyper parameter (α) appending the next layer (t), returning the first hyper-parameter (λ) and the second hyper parameter (α).

### CROSS-REFERENCE TO RELATED APPLICATIONS

The present application is a National Stage Application under 35 U.S.C. § 371 of International Patent Application No. PCT/EP2022/085958 filed on Dec. 14, 2022, and claims priority from German Patent Application No. 10 2021 214 984.7 filed on Dec. 23, 2021, in the German Patent and Trademark Office, the disclosures of which are herein incorporated by reference in their entireties.

### TECHNICAL FIELD

The present invention relates to the field of digital data processing and digital communications.

### BACKGROUND

Multidimensional discrete signal detection problems arise in various areas of modern digital data processing applications, including audio and video systems, control systems, communication systems, and more. In general, the aim is to extract informative quantities out of a limited number of observed measurements subject to random distortion, where the information is generated from sources according to a systematic model (coding book, constellation, etc.) known to the observer. The main challenge in such problems is the prohibitive size of the combinatorial discrete solution space that needs to be exhaustively searched in order to achieve optimal brute-force performance, whose dimension grows explosively with the number of sources and the cardinality of corresponding alphabets. Although there are conventional tree-search approaches that alleviate the search complexity of the brute-force method, one still suffers from the nature of exponential growth in complexity with respect to the signal dimension.

Recently, much progress has been made in this area by the introduction of compressed sensing techniques, leading to discreteness-aware methods relying on a sum of [symbol] -norm regularization approach that enables the search space to be continuous with adherence to the prescribed discrete alphabets.

Despite the excellence of the precedents in performance and complexity, the latter approaches uncovered no explicit connection with the widely-adopted linear estimation methods in related signal processing applications such as least square (LS) and linear minimum mean squared error (LMMSE) estimators. Thus, a challenge has been raised to explore the relationship between such linear estimators and the aforementioned discreteness-aware detection methods.

In the derivation of conventional linear LS and LMMSE filters for multidimensional linear models, it is also typically assumed that the intended signal vector is continuous in order to compute the Wirtinger derivative. This, on the one hand, enables obtaining closed-form LS and LMMSE expressions satisfying the stationarity condition, but on the other hand results in sub-optimal performance due to the inconsistency between the assumption and the actual discrete condition of the input.

The aforementioned gap has most recently been fulfilled with a generalization of the closed-form LS and LMMSE for linear systems with discrete inputs, dubbed as the iterative discrete least square (IDLS). Although the IDLS has been shown to perform well both in determined and underdetermined (i.e., ill-posed) conditions, a challenging issue has been left to be conquered, which is tuning of hyperparameters introduced in the IDLS such as the weight of the regularizer and tightness of the [symbol] -norm approximation. Furthermore, such hyper-parameters in the IDLS have been assumed to be constant over the algorithm iterations, due to the complexity bottleneck when optimizing such hyper-parameters at each iteration.

The invention solves the problem of improving the recovery performance without increasing the complexity order of the IDLS framework by dynamically optimizing the hyperparameters over the iterations. The proposed method leverages the concept of deep-unfolding techniques that recast an iterative process into a layer-wise structure analogous to deep neural networks. With this modification to the IDLS framework, the parameter-tuning bottleneck is mitigated by supervised learning and backpropagation techniques without an exhaustive search on the multidimensional parameter space. In other words This invention proposes an innovative method to efficiently parameterize discrete digital signal recovery for underdetermined linear inversion problems with discrete inputs. As the number of devices grows as is the case with internet of things, the resultant lack of the wireless resources will be a bottleneck in wireless communications.

Vectors and matrices are denoted by letters in bold face and capitalized bold face, respectively. The [symbol] , [symbol] , and [symbol] norm is denoted by ∥⋅∥₁, ∥⋅∥₂, and ∥⋅∥_{∞}, respectively. The transpose, conjugate transpose, inverse, and diagonalize operations is represented as ⋅^{T}, ⋅^{H}, ⋅⁻¹, and diag (⋅), respectively. The M×M identity matrix, and the complex Gaussian distributions with mean μ and variance σ is denoted by I_{M}, and [symbol] [symbol] (μ, σ), respectively.

The patent applications of the applicant WO2021/083495, WO2021/198407 WO2021/198404 are incorporated by reference into this application.

The cited problem is solved by the embodiments. A first embodiment is characterized by a computer-implemented method to optimize hyper-parameters of discrete digital signal recovery for data processing system that is characterized by a measurement matrix (A), the method comprising a processing unit (PU) receiving a noisy observation vector (y) of scalar measurements (N) from an unknown signal vector (x) linearly transformed by the measurement matrix (A), where the unknown signal vector (x) is composed of quantities randomly sampled from a finite discrete alphabet set ( [symbol] ), recovering the unknown signal vector (x) from the noisy observation vector (y) by optimizing a first hyper-parameter (λ) and a second hyper parameter (α) by performing a standard supervised mini-batch training, whereby a training data set ( [symbol] ) is split (L) into mini-batches ( [symbol] ) and every mini-batch ( [symbol] ) is composed of many pairs of signal vectors (x) and noisy observation vectors (y), initializing a first function (\hat{X}^{IDLS-Net}) computing a second function (β_{i,j}(t)) computing a third function (b(t)), fourth function (B(t)) for every layer (t), calculating the first function (\hat{X}^{IDLS-Net}) based on the result of the second function (β_{i,j}(t)), third function (b(t)), fourth function (B(t)), whereby a loss function (Loss (t)) is determined at the end of every layer (t′) and the max operation is taken over the mini-batch ( [symbol] ), updating the first hyper-parameter (λ) and the second hyper parameter (α), appending the next layer (t), returning the first hyper-parameter (λ) and the second hyper parameter (α)

A further embodiment is characterized by, that the training data set ( [symbol] ) is generated by randomly generation on the noisy observation (y), the measurement matrix (A), signal vector (x) and the noise vector (n) according to the relationship y=Ax+n.

A further embodiment is characterized by the fact that the optimizing is done by deep learning techniques.

A further embodiment is characterized by the fact that the optimizing is done by stochastic gradient descent and back-propagation.

The additional embodiment is characterized by the fact, that the first function is defined by \hat{x}^{IDLS}=(A^{H}A+σ²I_{N}+λB)⁻¹(A^{H}y+λb),

The additional embodiment is characterized by the fact, that the second function is defined by

$${β}_{i , j} = \frac{\sqrt{α}}{\vert {\hat{x}}_{j} - {c}_{i} {\vert}^{2} + α} .$$

The additional embodiment is characterized by the fact, that the third function is defined by

$$b {=}^{Δ} {\sum }_{i = 1}^{\vert 𝒞 \vert} {{c}_{i} [ {β}_{i , 1}^{2} , {β}_{i , 2}^{2} , … , {β}_{i , M}^{2} ]}^{T} .$$

The additional embodiment is characterized by the fact, that the fourth function is defined by

$$B {=}^{Δ} {\sum }_{i = 1}^{\vert 𝒞 \vert} diag ( {β}_{i , 1}^{2} , {β}_{i , 2}^{2} , … , {β}_{i , M}^{2} ) .$$

The additional embodiment is characterized by the fact, that the data processing system is a communication system and processing unit (PU) is a user equipment (UE).

A further embodiment is a receiver (R) of a communication system having a processor, volatile and/or non-volatile memory, at least one interface adapted to receive a signal in a communication channel, wherein the non-volatile memory stores computer program instructions which, when executed by the microprocessor, configure the receiver to implement the method of one or more of claims 1-9.

A further embodiment is a computer program product comprising computer executable instructions, which, when executed on a computer, cause the computer to perform the method of any of claims 1-9.

A further embodiment is a computer-readable medium storing and/or transmitting the computer program product of claim 11.

A further embodiment is a data processing system, characterized by having at least one hyper-parameter node, where the method according to the claims 1 to 9 generates distinct subprocesses and hyper-parameters λ(t) and α(t) for every layer (t) and after processing the maximum numbers of the iterations (T) the subprocess the hyper-parameter node are optimized layerwise within the data processing system.

A further embodiment is a data processing system characterized by having at least one hyper-parameter node, where the method according to the claims 1 to 9 generates distinct subprocesses and hyper-parameters λ(t) and α(t) for every layer (t) and after processing the maximum numbers of the iterations (T) the subprocess the hyper-parameter node are optimized layerwise within the multimedia system.

A further embodiment is a control system, characterized by having at least one hyper-parameter node, where the method according to the claims 1 to 9 generates distinct subprocesses and hyper-parameters λ(t) and α(t) for every layer (t) and after processing the maximum numbers of the iterations (T) the subprocess the hyper-parameter node are optimized layerwise within the control system.

Generally spoken the inventive solution is a combination of the detection mechanism and deep-unfolding techniques. A new model-based artificial deep neural system with the neurons representing the hyper-parameters to be optimized is described. The network and/or the system is trained in a supervised manner over known input/output pairs, such that the resultant solution from the network/the system may reduce the mean square error. The hyper parameters are to be allowed to be dynamic over different layers (iterations), that means, different hyper-parameters to be used for different iterations.

### BRIEF SUMMARY

Embodiments of the invention propose a new dynamic parameterization approach via deep unfolding as an extension of the recently introduced iterative discrete least square (IDLS) scheme, shown to generalize the conventional linear minimum mean squared error (LMMSE) method to enable the solution of inversion problems in complex multidimensional linear systems subject to discrete inputs. Configuring a layer-wise structure analogous to a deep neural network, the new method enables an efficient optimization of the iterative IDLS algorithm, by finding optimal hyper-parameters for the related optimization problem through backpropagation and stochastic gradient descent techniques. The effectiveness of the proposed approach is confirmed via computer simulations.

### BRIEF DESCRIPTION OF THE DRAWINGS

Embodiments of the invention will be further explained with reference to the drawings.

FIG. 1 shows the illustration of the proposed system model.

FIG. 2 shows the SER performance as a function of SNR.

FIG. 3 shows the learned hypers parameters λ and α with respect to the number of iterations.

FIG. 4 shows the implementation of one embodiment of the System.

FIG. 5 shows the general functional relation in interaction with the proposed method.

In the drawings identical or similar elements may be referenced by the same reference designators.

### DETAILED DESCRIPTION

Among existing methodologies, there are mathematical, i.e., optimization-based approaches to address inversion problems with discrete inputs. However, one of the drawbacks is that it requires an exhaustive hyper-parameter search. This numerical search may limit the application of the method proposed in WO2021/083495, WO2021/198407, WO2021/198404 in practice, thus results in the motivation to improve the efficient mechanism to parameterize the latter without any numerical search.

The limitation is that all require hyper-parameter tuning via numerical exhaustive search, which prevents feasibility of those methods in practice. Due to the limited number of computational resources, such exhaustive searches end up with a compromise solution, capitulating to sub-optimal performance.

### System Description

It is assumed that a noisy observation vector y of N scalar measurements is obtained from an unknown signal vector x linearly transformed by the measurement matrix A, where the vector x is composed of quantities randomly sampled from a finite discrete alphabet set [symbol] ≙{c₁, c₂, . . . , [symbol] }, which can be expressed as the widely-employed matrix linear model:

$$y = A x + n , \qquad ( 1 )$$

with y∈ [symbol] , A∈ [symbol] , x∈ [symbol] , and the noise vector n˜ [symbol] [symbol] (, σ²I_{M}) Recovering the input vector x from the noisy measurement y is a well-known linear inverse problem, in which an estimate can be obtained by solving

$${minimize}_{x ∈ {ℂ}^{M}} {‖ y - Ax ‖}_{2}^{2} , \qquad ( 2 )$$

yielding the well-known LS solution given by

$${{\hat{x}}^{LS}}^{} = {( {A}^{H} A )}^{- 1} {A}^{H} y , \qquad ( 3 )$$

where the solution exists if N≥M.

In order to avoid noise amplification at low signal-to-noise ratio (SNR) regimes, one can regularize equation (2) by a weighted [symbol] -norm such that

$${minimize}_{x ∈ {ℂ}^{M}} {‖ y - Ax ‖}_{2}^{2} + {σ}^{2} {‖ x ‖}_{2}^{2} , \qquad ( 4 )$$

which yields the LMMSE solution given by

$${\hat{x}}^{{}_{LMMSE}} = {( {A}^{H} A + {σ}^{2} {I}_{M} )}^{- 1} {A}^{H} y = {{A}^{H} ( A {A}^{H} + {σ}^{2} {I}_{N} )}^{- 1} y \qquad ( 5 )$$

Although the above two well-known solutions have been leveraged in many signal processing applications, the latter solutions have two drawbacks. First, it fails to incorporate the prior information that the inputs are discrete and sampled from a certain set with finite alphabets and, second, it is inappropriate to utilize such solutions for ill-posed problems such as M>N and rank-deficient A. The major difficulty is that incorporating such discreteness of the input vector may lead to a combinatorial optimization problem as illustrated by

$${minimize}_{x ∈ {𝒞}^{M}} {‖ y - Ax ‖}_{2}^{2} , \qquad ( 6 )$$

in which the global optimal solution can be obtained by a brute-force search over | [symbol] |^{M} possible combinations.

Addressing this complexity bottleneck for inverse problems with discrete inputs, it has been considered a sum- [symbol] -norm regularization approach, which can be compactly written as

$${minimize}_{x ∈ {ℂ}^{M}} {‖ y - Ax ‖}_{2}^{2} + λ {\sum }_{i = 1}^{\vert 𝒞 \vert} {‖ x - {c}_{i} 1 ‖}_{0} \qquad ( 7 )$$

where the second term is minimized when every entry in x equates to any of the alphabets {c₁, c₂, . . . , [symbol] } and λ is a regularization parameter.

Among existing approximated solutions to the non-convex regularized problem in equation (7) such as Douglas-Rachford algorithm based approach, alternating direction method of multipliers (ADMM) based approach, and linear programming relaxation approach, the inventors have recently proposed a direct generalization of the conventional LS and LMMSE estimate with adherence to the prescribed discrete alphabets, dubbed as IDLS, whose solution is given by iteratively updating a linear closed-form solution. To elaborate, the IDLS consists of the following equations:

$${\hat{x}}^{{}_{IDLS}} = {( {A}^{H} A + {σ}^{2} {I}_{N} + λ B )}^{- 1} ( {A}^{H} y + λ b ) , \qquad ( 8 a )$$

With

$$b {=}^{Δ} {\sum }_{i = 1}^{\vert 𝒞 \vert} {{c}_{i} [ {β}_{i , 1}^{2} , {β}_{i , 2}^{2} , … , {β}_{i , M}^{2} ]}^{T} \qquad ( 8 b )$$

$$B {=}^{Δ} {\sum }_{i = 1}^{\vert 𝒞 \vert} diag {( {β}_{i , 1}^{2} , {β}_{i , 2}^{2} , … , {β}_{i , M}^{2} )}^{T} \qquad ( 8 c )$$

where

$${β}_{i , j} = \frac{\sqrt{α}}{{\vert {\hat{x}}_{j} - {c}_{i} \vert}^{2} + α} for all \begin{matrix}i ∈ \{ 1 , … , \vert 𝒞 \vert \} \\ j ∈ \{ 1 , … , M \}\end{matrix} , \qquad ( 8 d )$$

where λ∈ [symbol] , and α∈ [symbol] , are the hyper-parameters.

It has to be noticed that equation (8a) is a generalization of the LS and LMMSE as equation (8a) results into equation (3) and (5) when the regularization parameter λ approaches 0.

### Dynamic Parameterization for IDLS (System)

The challenge of the latter solution is the necessity of numerically searching the hyper-parameters λ and α, resulting in a 2-dimensional search over the first quadrant in Cartesian coordinate as both hyperparameters are non-negative. Such hyper-parameters search problems can be heuristically solved via efficient exhaustive search algorithms such as grid search, random search, and Bayesian optimization. However, the heuristic approaches are known to suffer from scalability. Although the authors proposed in an alternative solution via a quadratically constrained quadratic program (QCQP) reformulation to find sub-optimal λ, this approach requires us to specify a search space that is dependent on ∥n∥₂².

Yet another bottleneck is that the IDLS considers fixed λ and α over the iterations. Due to the lack of freedom and flexibility, this constant parameterization may pose limitation in the recovery performance. Having clarified that, it has to be remarked that both aforementioned heuristic and QCQP approaches are not suited to dynamically optimize λ and α at each iteration due to the complexity.

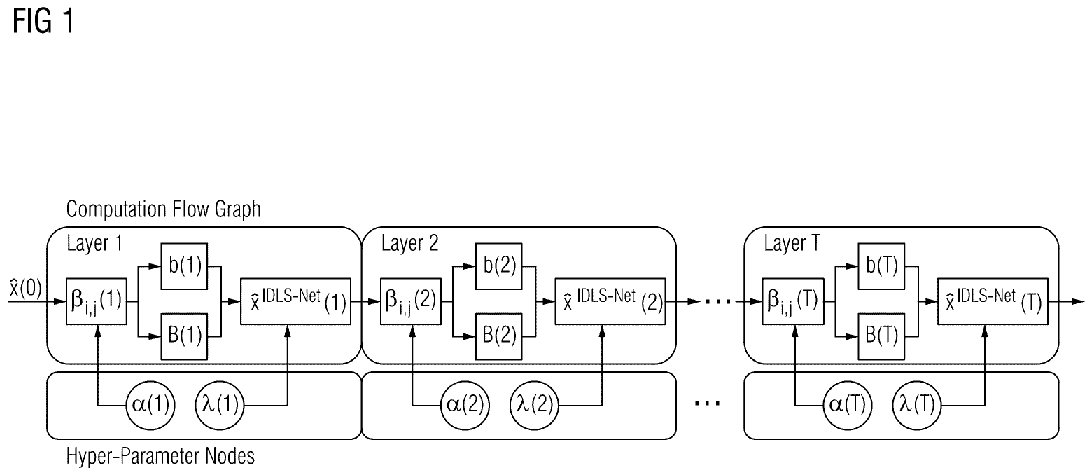

FIG. 1 shows the illustration of the proposed network/system model. The computation network/system model depicts the iterative calculations of the IDLS as in equation (9a)-(9d), while the gray-colored circles represent the hyper-parameters that are optimized through backpropagation and stochastic gradient descent.

The iteration index t∈{1,2, . . . , T} with T denoting the maximum number of iterations is introduced, letting λ(t) and α(t) be hyper-parameters λ and α at the t-th iteration, as shown in FIG. 1.

A novel extension of IDLS via the deep-unfolding technique with the aim of efficiently optimizing λ(t) and α(t) for all t is proposed. The goal of this is to provide a method that automatically tunes a set of 2T distinct hyper-parameters without an exhaustive search such that the recovery performance improves with a reasonable time consumption.

### Network/System Model

In FIG. 1, the schematized computation flow graph of the proposed method is illustrated, where the iterative process is unfolded into T distinct subprocesses and hyper-parameters λ(t) and α(t) for given t are fed into the t-th sub-process. The proposed method is built upon the concept of deep-unfolding that recast iterative processes into a layer-wise structure analogous to a neural network. The newly introduced tunable parameters are then optimized using deep learning techniques such as stochastic gradient descent and back-propagation.

In this section, a first proposed network model as a novel extension of the IDLS, where the dynamic parameterization is enabled, is introduced. The proposed method consists of the following recursion:

$${\hat{x}}^{{}_{IDLS - Net}} ( t ) = {( {A}^{H} A + {σ}^{2} {I}_{N} + λ ( t ) B ( t ) )}^{- 1} ( {A}^{H} y + λ ( t ) b ( t ) ) , \qquad ( 9 a )$$

With

$$\begin{matrix}b ( t ) & {\sum }_{i = 1}^{\vert 𝒞 \vert} {{c}_{i} [ {β}_{i , 1}^{2} ( t ) , {β}_{i , 2}^{2} ( t ) , … , {β}_{i , M}^{2} ( t ) ]}^{T} ,\end{matrix} \qquad ( 9 b )$$

$$\begin{matrix}B ( t ) & {\sum }_{i = 1}^{\vert 𝒞 \vert} diag ( {β}_{i , 1}^{2} ( t ) , {β}_{i , 2}^{2} ( t ) , … , {β}_{i , M}^{2} ( t ) ) ,\end{matrix} \qquad ( 9 c )$$

where

$${β}_{i , j} ( t ) = \frac{\sqrt{α ( t )}}{{\vert {\hat{x}}_{j} ( t ) - {c}_{i} \vert}^{2} + α ( t )} , \begin{matrix}i ∈ \{ 1 , … , \vert 𝒞 \vert \} and \\ j ∈ \{ 1 , … , M \}\end{matrix} \qquad ( 9 d )$$

Although the proposed method inherits the iterative process from the IDLS, a fundamental difference is that the proposed method adopts different hyper-parameters for each iteration. On the one hand, as shown in equation (7), changing λ at each iteration indicates that the regularization weight over the iteration is adjusted, which allows additional degrees of freedom. On the other hand, hyper-parameter α controls tightness of the [symbol] -norm approximation relative to the original [symbol] -norm given in equation (7), indicating that the regularization function itself by changing α for each iteration is adjusted. The additional degrees of freedom gifted by dynamic parameterization of the two distinct quantities may leave potential for further recovery performance improvements. It should be noted that such dynamic parameterization was challenging due to the prohibitive complexity needed for heuristic approaches as mentioned earlier. For the sake of brevity, the proposed network/system model is called IDLS-Net.

### Method: Training

In this section, it is described how the proposed network illustrated in FIG. 1 is trained. The parameter optimization is performed by a standard supervised mini-batch training as in the case with deep neural networks for inference problems. It is supposed that a training data set [symbol] is split into L mini-batches, i.e., [symbol] =∪ₗ₌₁^{L} [symbol] with [symbol] denoting the l-th mini-batch. Each mini-batch [symbol] is composed of many pairs of input and output vectors such that

$${𝒟}_{l} = \{ ( {x}_{l}^{1} , {y}_{l}^{1} ) , ( {x}_{l}^{2} , {y}_{l}^{2} ) , … , ( {x}_{l}^{{}_{\vert {𝒟}_{l} \vert}} , {y}_{l}^{\vert {𝒟}_{l} \vert} ) \} , \qquad ( 10 )$$

where the pair (xₗⁱ, yₗⁱ) is randomly generated according to equation (1) with i∈{1,2, . . . , | [symbol] |}.

Given [symbol] , our objective is to minimize the empirical largest square error (LSE) between the true input vector xₗⁱ and the corresponding estimate \hat{x}^{IDLS-Net}(t) over [symbol] , that is,

$$Loss ( t ) = {max}_{{𝒟}_{l}} ( {‖ {x}_{l}^{i} - {\hat{x}}^{{}_{IDLS - Net}} ( t ) ‖}_{∞} \vert {y}_{l}^{i} ) , \qquad ( 11 )$$

where Loss (t) denotes the LSE loss function evaluated at the end of the t-th layer for any t∈{1,2 , . . . , T} and the max operation is taken over the mini-batch.

The training is done in an incremental manner such that harmful vanishing gradient problem can be bypassed, in which the IDLS-Net is incrementally deepened on a layer-by-layer basis. To elaborate further, it is supposed, having t layers of the IDLS-Net with t∈{1,2, . . . , T−1}.

Lₜ be the number of mini-batches to train the truncated IDLSNet with depth t, where L=ΣₜLₜ, the forward and backward propagation through the network to update the hyperparameters using stochastic gradient descent is processed for Lₜ different mini-batches, in which the objective function is given by equation (11) and the corresponding gradient direction is computed by backpropagation. After processing Lₜ mini-batches through the network, the (t+1)-th layer is concatenated to the trained truncated IDLS-Net with depth of t, training the t+1 layers by the forward and backward propagation with Lₜ₊₁ mini-batches. This recursive process is terminated when t+1 reaches the maximum number of layers T, namely, t+1=T.

The described method is show in the next tableau, describing all single steps.

Method to optimize hyper-parameters of discrete digital signal

```
Input: [symbol]     and T
Output: {λ₁, ..., λ_{T}} and {α₁, ..., α_{T}}
  1: for t = 1, ..., T
  2: Retrieve Lₜ mini-batches from [symbol]    .
  3: for lₜ = 1, ..., Lₜ
  4: Sample mini-batch [symbol]    ₗ_{ₜ}.
  5: Initialize \hat{X}^{IDLS-Net}(0) = 0.
  6: for t′ = 1, ..., t
  7: Compute β_{i,j}(t) by eq. (9 d).
  8: Compute b(t) and B(t) by eq. (9b) and (9c), respectively.
  9: Compute \hat{x}^{IDLS-Net} (t) by eq. (9a).
10: end for
11: Compute the current loss by eq. (11).
12: Update hyper-parameters by backpropagation.
13: end for
14: Append the ( t + 1)-th layer to the network.
15: end for
16: Output the trained hyper-parameters.
```

The training process is summarizes described above in the cited method 1. The training data set [symbol] and the maximum number of iterations T are put into the method, while the method outputs trained hyper-parameters {λ₁, . . . , λ_{T}} and {α₁, . . . , α_{T}}. It should be noted that the training data set [symbol] is generated according to equation (1) with random y, A, x, and n, wherein the (t+1)-th layer is appended to the network, the hyper-parameters from the first layer to the t-th layer at the previous iteration are leveraged as initial values at the next iteration. As briefly noted earlier, the number of hyper-parameters to be tuned is 2T, which is significantly smaller than that of standard deep neural networks, enabling fast training.

Performance evaluation of the proposed method in comparison with the state-of-the-art methods is described. For the sake of comparison, the independent and identically distributed complex Gaussian distribution is considered to model each element of the measurement matrix A; in other words, [A]_{i,j}˜ [symbol] [symbol] (0,1) with i and j denoting the column and row index, respectively.

As for the signaling, following the transmission scheme of digital wireless communications, modeling each element of x to be drawn from offset quadrature phase-shift keying (QPSK) modulation. Besides, the aspect ratio γ≙M/N is set to 1.2, indicating that the input dimension is 20% larger than the observation dimension. The implementation of the proposed deep unfolding framework is done on PyTorch platform and Adam optimizer with a learning rate initialized by Optuna. In addition, the number of layers (i.e., T) is assumed to be T=25 and the target SNR is set to 18 [dB]. In this section, the IDLS method with the optimal constant parameters as a state-of-the-art method is considered, while leveraging the matched filter bound (MFB) as an absolute performance lower bound.

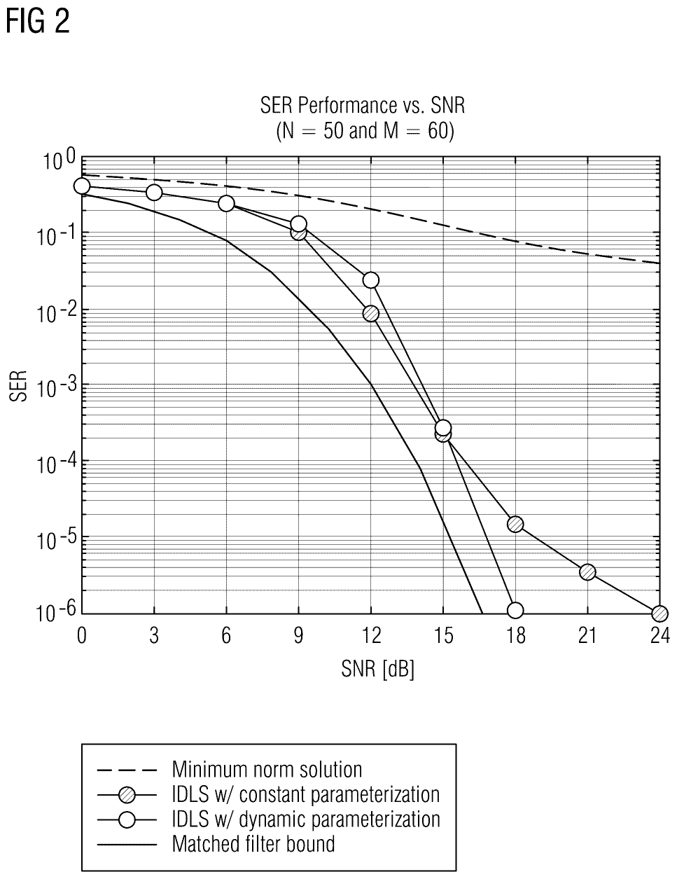

FIG. 2 shows the SER performance as a function of SNR.

In FIG. 2, the symbol error rate (SER) performance of different methods with respect to the SNR in decibels is shown, where the dotted line indicates the performance of the minimum norm solution (MNS) (i.e., a LS solution in underdetermined systems), the solid line with black and white balls is respectively that of the IDLS with constant and dynamic parameterization, and the simple solid line corresponds to the MFB. As shown in the FIG. 2, it can be observed that the MNS results in a high detection error floor regardless of the SNR level, while the IDLS clearly shows its superiority over the former. More interestingly, the proposed dynamic parameterization of the IDLS is shown to avoid an error floor that the state-of-the-art IDLS with constant parameterization suffers from, demonstrating an SNR gain of approximately 6 [dB] at SER=10⁻⁶. This is due to the fact that the proposed approach allows additional degrees of freedom to the IDLS framework over iterations. Also, notice that this dynamic parameterization has been practically difficult without the introduction of deep unfolding due to the high complexity of an exhaustive parameter search. One can also observe from the figure that the proposed dynamic parameterization of the IDLS demonstrates a similar SER trend with that of the MFB, approaching within approximately 1.5 [dB] from the latter at SER=10⁻⁶.

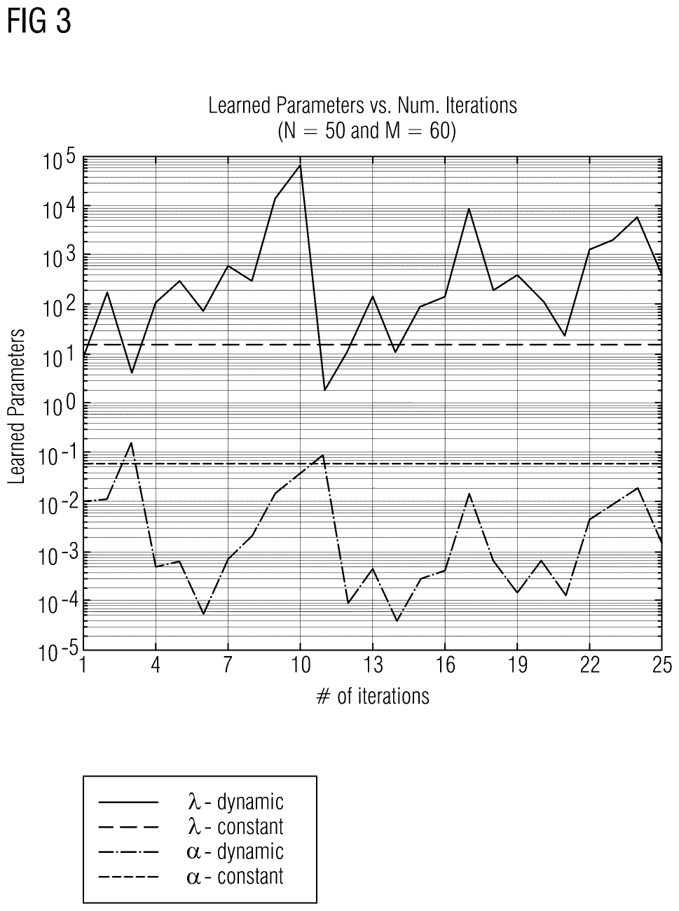

FIG. 3 shows the learned parameters λ and α with respect to the number of iterations.

A comparison between learned parameters of the constant and dynamic approaches is offered as a function of the number of iterations in FIG. 3, where the red lines correspond to the value of learned λ while the blue lines indicate that of learned α. Many insights can be perceived from the figure. First, one can notice that interestingly, the optimal λ and α for the constant approach are not the mean of the dynamically-optimized parameters, indicating that the constant approach may result in the lack of degrees of freedom and limits the performance of the IDLS. Secondly, the learned parameters via the dynamic approach demonstrate a non-smooth zigzag behavior, which resembles findings as Chebyshev polynomials. Lastly, comparing the solid red line with the solid blue line, it is interesting that these two lines are in opposite phase from each other until 11-th iteration, while being in coordinate phase from 12-th iteration until the end. The aforementioned zigzag behavior as well as the phase transition is a key for the performance improvement via the dynamic parameterization through deep unfolding.

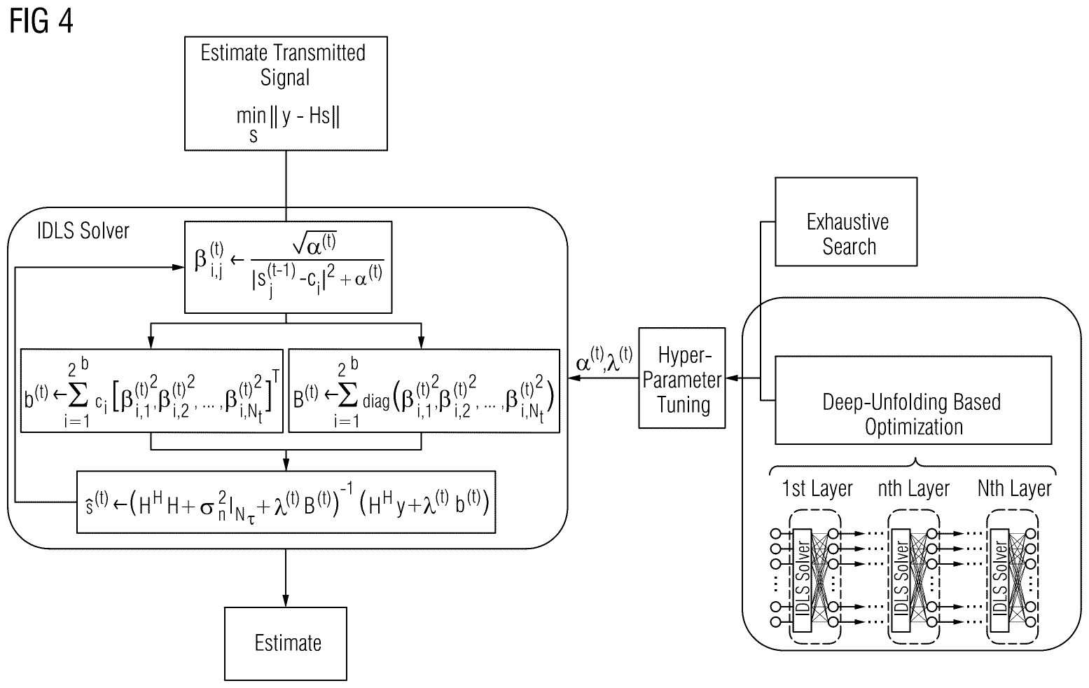

FIG. 4 shows the implementation of one embodiment of the System.

The flow-chart in FIG. 4 illustrates the interaction of the represented result of equation of (9a)-(9d) and the deep-unfolding based optimization in order to gain the overall estimation. In FIG. 4 all process steps are represented by the functional relevant equivaled equations described above.

In the context of the present application and claims, as an embodiment a communication system is considered. The communication system is able to establish communications channels through any suitable medium, e.g., a medium that carries electromagnetic, acoustic and/or light waves.

The inventive receiver of the inventive communication system has a processor, volatile and/or non-volatile memory and at least one interface adapted to receive a signal in a communication channel. The non-volatile memory may store the computer program instructions which, when executed by the microprocessor, configure the receiver to implement one or more embodiments of the method in accordance with the invention. The volatile memory may store parameters and other data during operation. The processor may be called one of a controller, a microcontroller, a microprocessor, a microcomputer and the like. And, the processor may be implemented using hardware, firmware, software and/or any combinations thereof. In the implementation by hardware, the processor may be provided with such a device configured to implement the present invention as ASICs (application specific integrated circuits), DSPs (digital signal processors), DSPDs (digital signal processing devices), PLDs (programmable logic devices), FPGAs (field programmable gate arrays), and the like.

Meanwhile, in case of implementing the embodiments of the present invention using firmware or software, the firmware or software may be configured to include modules, procedures, and/or functions for performing the above-explained functions or operations of the present invention. The firmware or software configured to implement the present invention is loaded in the processor or saved in the memory to be driven by the processor. It is clear that the execution of the program could be done within the communication system, the multimedia system, the data processing system or the control system and/or in the inventive receiver.

In order to gain data set [symbol] a transmitter T and a receiver R that communicate over a communication channel can be used. Transmitter T may include, inter alia, a source digital data that is to be transmitted. Source provides the bits of the digital data to an encoder, which forwards the data bits encoded into symbols to a modulator. Modulator transmits the modulated data into the communication channel, e.g. via one or more antennas or any other kind of signal transmitter. The modulation may be for example a Quadrature Phase-Shift Keying Modulation (QPSK). Channel may be a wireless channel. However, the approach is valid for any type of channel, wired or wireless. In the context of the present invention the medium can be a shared medium, i.e., multiple transmitters and receivers having access to the same medium and, more particularly, the channel is shared by multiple transmitters and receivers.

Receiver R receives the signal through communication channel e.g. via one or more antennas or any other kind of signal receiver. Communication channel may have introduced noise to the transmitted signal, and amplitude and phase of the signal may have been distorted by the channel. The distortion may be compensated by an equalizer provided in the receiver that is controlled based upon channel characteristics that may be obtained, e.g., through analysing symbols with known properties transmitted over the communication channel. Noise may be reduced or removed by a filter in the receiver. A signal detector receives the signal from the channel and tries to estimate, from the received signal, which signal had been transmitted into the channel. Signal detector forwards the estimated signal to a decoder that decodes the estimated signal into an estimated symbol. If the decoding produces a symbol that could probably have been transmitted it is forwarded to a de-mapper, which outputs the bit estimates corresponding to the estimated transmit signal and the corresponding estimated symbol, e.g., to a microprocessor for further processing and storing as a data set [symbol] sample. While the transmitter T and receiver R appear generally known, the receiver R, and more particularly the signal detector and decoder of the receiver in accordance with the invention are adapted to execute the inventive method described hereinafter with reference to FIG. 4 and thus operate differently than known receiver with signal detectors.

Generally spoken the receiver is part of a user equipment. A user equipment means the equipment designed for consumer use. It is any device used by an end user such as a smart phone or other mobile device, laptop, or tablet equipped with at least one wired or wireless broadband adapter. This means that the interaction with a digital data processing system, control system, communication system and multimedia system is done by a user equipment and the user equipment is executing the proposed method in corporation with a digital data processing, control system, communication system and multimedia system.

In the example explained in FIGS. 1 to 4 it is sufficient to unroll a small number of iterations, training is mostly straightforward. As a beneficial improvement can be done by using multi-loss functions, incremental training, or by simply using a set of known good initial values to minimize training. Another solution could be to perform windowed training, where unfolded iterations are trained only over a moving window of fixed size. By this approach a significantly reduction of the memory required for training can be achieved, which may become a limiting factor when considering algorithms with high-dimensional inputs (e.g., in massive MIMO) and a large number of iterations, since all intermediate output values of each mini-batch need to be stored for back-propagation. Online training methods that adapt to, e.g., changing channel or SNR conditions could be addressed by the proposed method.

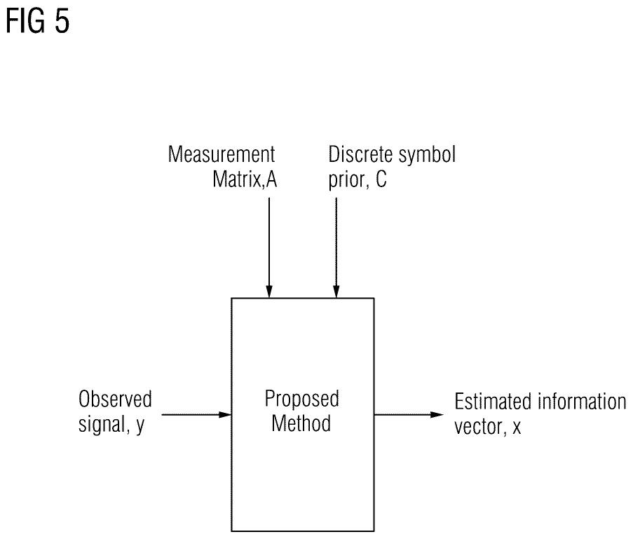

FIG. 5 shows the general functional relation in interaction with the proposed method, which means, that the proposed method the vector y is the “input”, matrix A is the “known prior, in addition to the known prior constellation C”, and the vector x is the “unknown information”. as it is depicted. The method will aim to generate an estimate of the unknown information vector x, in hand of the input y and the matrix A. This means given the observed signal y, given the prior information of the measurement matrix A and the discrete symbol prior C, estimation the information vector x is determined.

It has been shown in this invention that a dynamic parameterization approach via deep unfolding is capable of improving the recovery performance of IDLS for a complex multidimensional linear system subject to discrete inputs, bypassing an exhaustive hyper-parameter search over 2T dimensions. The simulation results demonstrate that the proposed method is avoiding a symbol detection error floor that has been a main bottleneck of the state-of-the-art method with the optimal constant parameters, illustrating a similar trend with the curve of the theoretical lower bound.

This means that this approach leads to a better recovery and better detection performance. The method provides optimized parameters that together with the proposed receiver results in a better detection performance.

Furthermore, a fast training in terms of time is achieved. A model-based deep learning architecture has been used, and hence, the number of parameters to be optimized is significantly reduced; thus, the training can be completed within the order of minutes. It has to be noticed that the systems employed in the deep learning architecture is, indeed, the receiver which has been developed. Also, it should be noted that deep neural networks need many parameters in general, meaning that a plenty of training time is needed to train all of them.

Additionally, the proposed approach assumes neither any channel statistics nor modulation configuration. Therefore, it can learn parameters without modification on the method for different channel and modulation situations such as correlated MIMO channels, millimeter wave channels, etc.

As already mentioned, the method and the network/system can be implemented in a software implementation like data processing systems, communication system or Cellular networks, particularly wireless communication systems, e.g., 5G+ and 6G, and/or in Multimedia System with Video-and Audio Application and Control-Systems where artificial intelligence and machine learning concepts are envisioned to be used to optimize the performance. Especially the performance of the radio access network will be significantly and beneficially increased by the proposed method.

Concerning the generation of the batches many variations to select the mini-batch, for different machine learning objectives can be used. For example, the varying size and number of the mini-batches, ensuring a certain fairness criteria in the selection of each batch, etc. generically speaking alternatives could be the different characteristics of the smaller data-units (batches).

1. A computer-implemented method to optimize hyper-parameters of discrete digital signal recovery for a data processing system that is characterized by a measurement matrix (A),
the method comprising:
a processing unit (PU) receiving a noisy observation vector (y) of scalar measurements (N) from an unknown signal vector (x) linearly transformed by the measurement matrix (A), where the unknown signal vector (x) is composed of quantities randomly sampled from a finite discrete alphabet set ( [symbol] )
recovering the unknown signal vector (x) from the noisy observation vector (y) by
optimizing a first hyper-parameter (λ) and a second hyper parameter (α) by performing a standard supervised mini-batch training, whereby a training data set ( [symbol] ) is split (L) into mini-batches ( [symbol] ) and every mini-batch ( [symbol] ) is composed of many pairs of signal vectors (x) and noisy observation vectors (y),
initializing a first function (\hat{X}^{IDLS-Net}) computing a second function (β_{i,j}(t)) computing a third function (b(t)), fourth function (B(t)) for every layer (t), calculating the first function (\hat{X}^{IDLS-Net}) based on the result of the second function (β_{i,j}(t)), third function (b(t)), fourth function (B(t))
whereby a loss function (Loss (t)) is determined at the end of every layer (t′) and the max operation is taken over the mini-batch ( [symbol] ).
updating the first hyper-parameter (λ) and the second hyper parameter (α)
appending the next layer (t),
returning the first hyper-parameter (λ) and the second hyper parameter (α).

2. The method of claim 1, wherein the training data set ( [symbol] ) is generated by randomly generation on the noisy observation (y), the measurement matrix (A), signal vector (x) and the noise vector (n) according to the relationship y=Ax+n.

3. The method of claim 1, wherein the optimizing is done by deep learning techniques.

4. The method of claim 3, wherein the optimizing is done by stochastic gradient descent and back-propagation.

5. The method of claim 1, wherein the first function is defined by \hat{x}^{IDLS}=(A^{H}A+σ²I_{N}+λB)⁻¹(A^{H}y+λb).

6. The method of claim 1, wherein the second function is defined by
$${β}_{i , j} = \frac{\sqrt{α}}{{\vert {\hat{x}}_{j} - {c}_{i} \vert}^{2} + α} .$$

7. The method of claim 1, wherein the third function is defined by
$$b {=}^{Δ} {\sum }_{i = 1}^{\vert 𝒞 \vert} {{c}_{i} [ {β}_{i , 1}^{2} , {β}_{i , 2}^{2} , … , {β}_{i , M}^{2} ]}^{T} .$$

8. The method of claim 1, wherein the fourth function is defined by
$$B {=}^{Δ} {\sum }_{i = 1}^{\vert 𝒞 \vert} diag {( {β}_{i , 1}^{2} , {β}_{i , 2}^{2} , … , {β}_{i , M}^{2} )}^{T} .$$

9. The method of claim 1, wherein the data processing system is a communication system and processing unit (PU) is a user equipment (UE).

10. A receiver (R) of a communication system having a processor, volatile and/or non-volatile memory, at least one interface adapted to receive a signal in a communication channel, wherein the non-volatile memory stores computer program instructions which, when executed by the microprocessor, configure the receiver to optimize hyper-parameters of discrete digital signal recovery for the communication system that is characterized by a measurement matrix (A), by performing operations comprising:
the processor (PU) receiving a noisy observation vector (y) of scalar measurements (N) from an unknown signal vector (x) linearly transformed by the measurement matrix (A), where the unknown signal vector (x) is composed of quantities randomly sampled from a finite discrete alphabet set ( [symbol] )
recovering the unknown signal vector (x) from the noisy observation vector (y) by
optimizing a first hyper-parameter (λ) and a second hyper parameter (α) by performing a standard supervised mini-batch training, whereby a training data set ( [symbol] ) is split (L) into mini-batches ( [symbol] ) and every mini-batch ( [symbol] ) is composed of many pairs of signal vectors (x) and noisy observation vectors (y),
initializing a first function (\hat{X}^{IDLS-Net}) computing a second function (β_{i,j}(t)) computing a third function (b(t)), fourth function (B(t)) for every layer (t), calculating the first function (\hat{X}^{IDLS-Net}) based on the result of the second function (β_{i,j}(t)), third function (b(t)), fourth function (B(t))
whereby a loss function (Loss (t)) is determined at the end of every layer (t′) and the max operation is taken over the mini-batch ( [symbol] ),
updating the first hyper-parameter (λ) and the second hyper parameter (α)
appending the next layer (t),
returning the first hyper-parameter (λ) and the second hyper parameter (α).

11. (canceled)

12. (canceled)

13. A data processing system characterized by having at least one hyper-parameter node, where computer-implemented operations to optimize hyper-parameters of discrete digital signal recovery for the data processing system generate distinct subprocesses and hyper-parameters λ(t) and α(t) for every layer (t) and after processing the maximum numbers of the iterations (T) the subprocess the hyper-parameter node are optimized layerwise within the data processing system, the computer-implemented operations comprising:
a processing unit (PU) receiving a noisy observation vector (y) of scalar measurements (N) from an unknown signal vector (x) linearly transformed by the measurement matrix (A), where the unknown signal vector (x) is composed of quantities randomly sampled from a finite discrete alphabet set ( [symbol] )
recovering the unknown signal vector (x) from the noisy observation vector (y) by
optimizing a first hyper-parameter (λ) and a second hyper parameter (α) by performing a standard supervised mini-batch training, whereby a training data set ( [symbol] ) is split (L) into mini-batches ( [symbol] ) and every mini-batch ( [symbol] ) is composed of many pairs of signal vectors (x) and noisy observation vectors (y),
initializing a first function (\hat{X}^{IDLS-Net}) computing a second function (β_{i,j}(t)) computing a third function (b(t)), fourth function (B(t)) for every layer (t), calculating the first function (\hat{X}^{IDLS-Net}) based on the result of the second function (β_{i,j}(t)), third function (b(t)), fourth function (B(t))
whereby a loss function (Loss (t)) is determined at the end of every layer (t′) and the max operation is taken over the mini-batch ( [symbol] ),
updating the first hyper-parameter (λ) and the second hyper parameter (α)
appending the next layer (t),
returning the first hyper-parameter (λ) and the second hyper parameter (α).

14. (canceled)

15. (canceled)

16. The receiver of claim 10, wherein the training data set ( [symbol] ) is generated by randomly generation on the noisy observation (y), the measurement matrix (A), signal vector (x) and the noise vector (n) according to the relationship y=Ax+n.

17. The receiver of claim 10, wherein the optimizing is done by deep learning techniques.

18. The receiver of claim 17, wherein the optimizing is done by stochastic gradient descent and back-propagation.

19. The data processing system of claim 13, wherein the training data set ( [symbol] ) is generated by randomly generation on the noisy observation (y), the measurement matrix (A), signal vector (x) and the noise vector (n) according to the relationship y=Ax+n.

20. The data processing system of claim 13, wherein the optimizing is done by deep learning techniques.

21. The data processing system of claim 20, wherein the optimizing is done by stochastic gradient descent and back-propagation.
